(19) United States
(12) Patent Application Publication
(10) Pub. No.: US 2009/0280347 A1
(43) Pub. Date: Nov. 12, 2009

(54) INSERT-MOLDED MEMBER MADE OF METAL AND PLASTIC AND METHOD FOR MAKING SAME

(75) Inventor: YUNG-MING YU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/171,271

(22) Filed: Jul. 10, 2008

(30) Foreign Application Priority Data
May 9, 2008 (CN) 200810301527.2

(51) Int. Cl. B29C 45/14

(52) U.S. Cl. 428/545; 264/273

(57) ABSTRACT

An exemplary insert-molded member (10) includes a metallic body (11), a plastic portion (12), and a bonding structure (13, 14, or 15). The metallic body is made of metallic material selected from the group consisting of magnesium alloy, aluminum alloy, and titanium alloy. The plastic portion is integrally formed with the metal body by insert-molding technology. The plastic portion is made of material selected from the group consisting of liquid crystal polymer, polyphenylene sulfide, and polybutylene terephthalate. The bonding structure is formed between the metallic body and the plastic portion. A method for making the method for making insert-molded member is also provided.

### BACKGROUND OF THE INVENTION

1. Field of the Invention

The present invention relates to insert-molded members, and perpendicularly to an insert-molded member made of metal and plastic, and a method for making the same.

2. Discussion of the Related Art

Electronic devices, such as mobile terminals or notebooks, may include integrated members made of metal and plastic. For example, a housing of a notebook computer may be an integrated member including a metallic body and a plastic antenna cover assembled to the metallic body. The plastic antenna cover is configured for avoiding electromagnetic shielding, thus signals can be successfully transmitted though the plastic antenna cover. The manner or method for forming an integrated member generally decides strength of the integrated member.

A typical integrated member made of metal and plastic includes a metallic body and a plastic cover assembled to the metallic body by a hook locking or a rivet jointing. However, a gap is generally defined between the metallic body and the plastic cover, thus the metallic body is easily detached from the plastic cover. In addition, when the thickness of the integrated member is small, the integrated member is easily cracked when the plastic cover is assembled to the metallic body by a hook locking or a rivet jointing, thus the mechanical strength of the integrated member is unduly low.

What is needed, therefore, is a insert-molded member made of metal and plastic which overcomes the above-described shortcomings. A method for making the insert-molded member made of metal and plastic is also needed.

### SUMMARY

In one aspect, an insert-molded member includes a metallic body, a plastic portion, and a bonding structure. The metallic body is made of metallic material selected from the group consisting of magnesium alloy, aluminum alloy, and titanium alloy. The plastic portion is integrally formed with the metal body by insert-molding technology. The plastic portion is made of material selected from the group consisting of liquid crystal polymer, polyphenylene sulfide, and polybutylene terephthalate. The bonding structure is formed between the metallic body and the plastic portion.

In another aspect, a method for making an insert-molded member, comprising the following steps: providing a metallic body made of metallic material selected from the group consisting of magnesium alloy, aluminum alloy, and titanium alloy, the metallic body including a bonding portion formed at an edge; and forming a plastic portion on the metallic body and at least one bonding structure between the metallic body and the plastic portion by insert-molding technology, the plastic portion made of material selected from the group consisting of liquid crystal polymer, polyphenylene sulfide, and poly butylene terephthalate.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present insert-molded member made of metal and plastic. Moreover, in the drawings, like reference numerals designate corresponding parts throughout the several views, and all the views are schematic.

FIG. 1 is an isometric view of an insert-molded member made of metal and plastic in accordance with an exemplary embodiment of the present invention.

FIG. 2 is similar to FIG. 1, but illustrates a plastic portion detached from a metallic body of the insert-molded member of FIG. 1.

FIG. 3 is a partially enlarged view of the insert-molded member of FIG. 1, showing the connection between the plastic portion the metallic body from another aspect.

FIG. 4 is a partial, cross-sectional view of the insert-molded member shown in FIG. 3, taken along the line IV-IV thereof.

FIG. 5 is an enlarged view of a circled portion V in FIG. 2.

FIG. 6 is a partial, cross-sectional view of the insert-molded member shown in FIG. 3, taken along the line VI-VI thereof.

FIG. 7 is a partial, cross-sectional view of the insert-molded member shown in FIG. 3, taken along the line VII-VII thereof.

### DETAILED DESCRIPTION OF THE EMBODIMENTS

Reference will now be made to the drawings to describe exemplary embodiments of the present insert-molded member made of metal and plastic in detail.

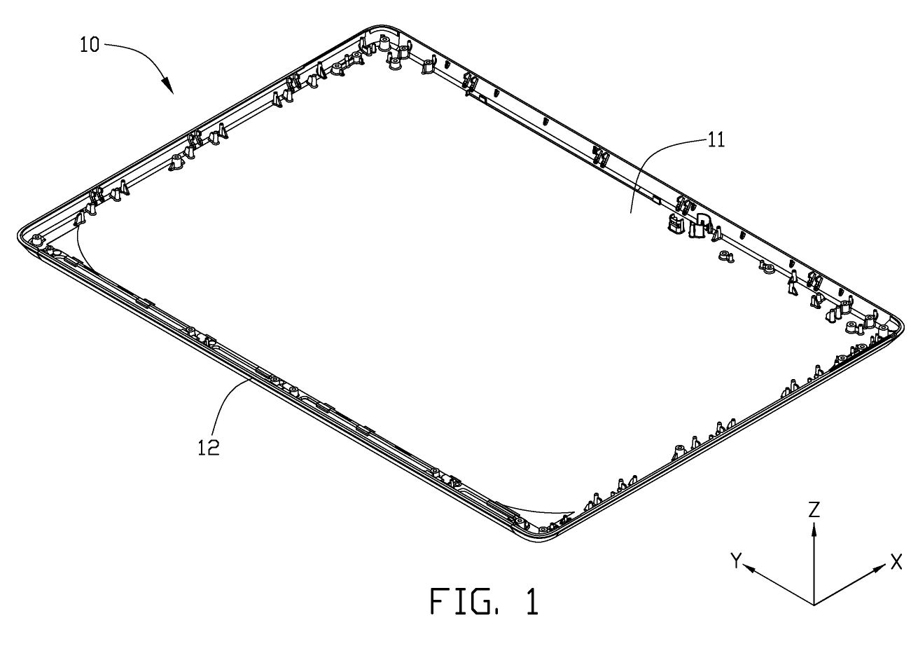

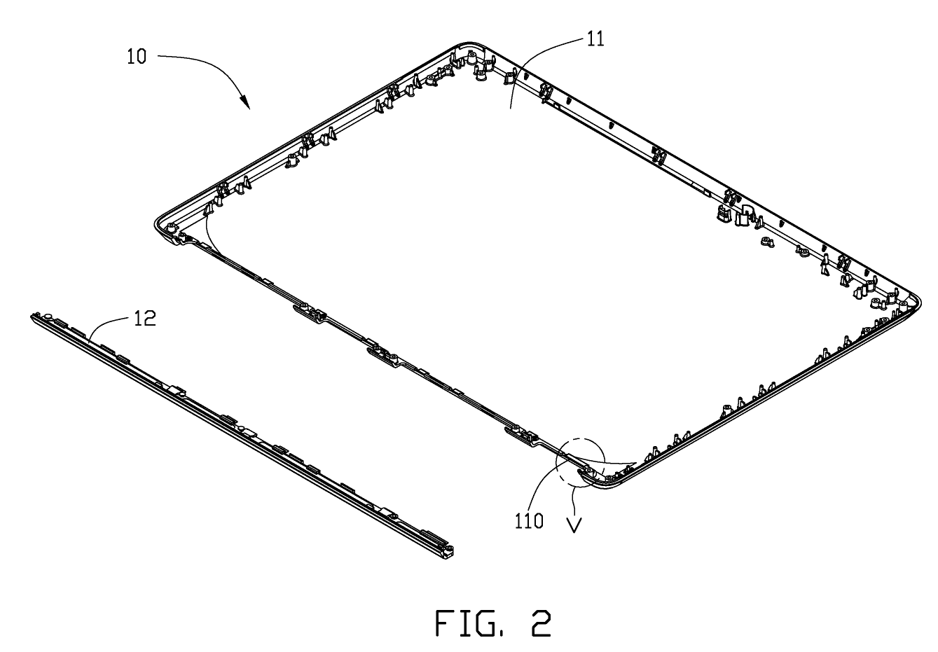

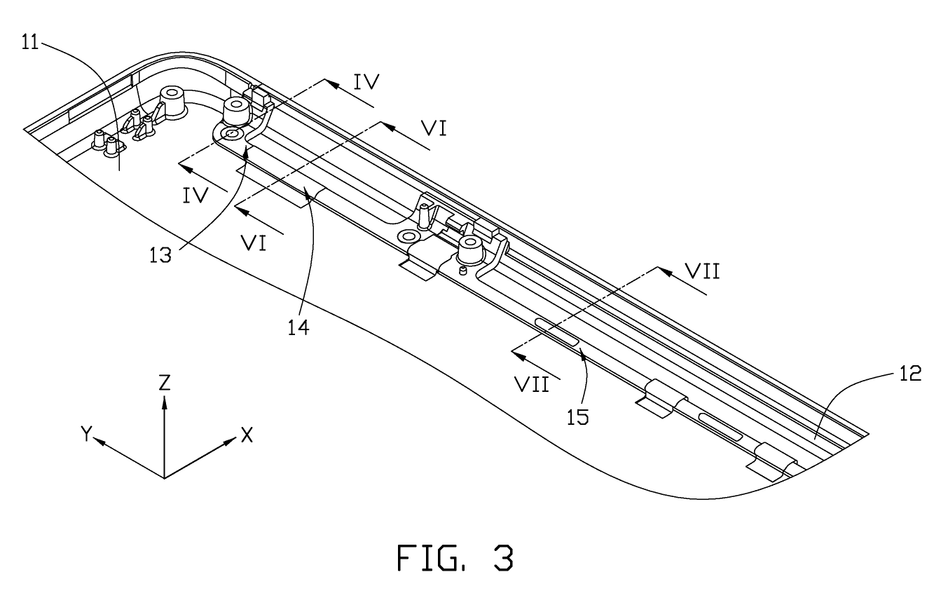

Referring to FIGS. 1 through 3, an insert-molded member 10, according to an exemplary embodiment of the present invention, is a housing adapted for electronic devices, such as notebook computers. The insert-molded member 10 includes a metallic body 11, a plastic portion 12 integrally insert-molded with the metallic body 11, a plurality of bonding structures 13, 14, 15 (see FIG. 3) formed between the metallic body 11 and the plastic portion 12. The metallic body 11 is substantially a rectangular metallic cover, which includes a plurality of bonding portions 110 formed on an edge. The bonding portions 110 are configured for joining with the plastic portion 12, to form the bonding structures 13, 14, 15. The metallic body 11 is made of a metallic material selected from the group consisting of magnesium (Mg) alloy, aluminum (AL) alloy, titanium (Ti) alloy, and any suitable combinations thereof. The bonding structures 13, 14, 15 are configured to improve the bonding strength between the metallic body 11 and the plastic portion 12.

The plastic portion 12 is substantially an elongated portion adjacent to one edge of the metallic body 11. The plastic portion 12 is made of a material which is able to be firmly bonded with the metallic body 11, for example, a material with relatively low shrinkage and a linear expansion coefficient substantially equal to that of the metallic material of the metallic body. The material of the plastic portion 12 may be selected from one of liquid crystal polymer (LCP), polyphenylene sulfide (PPS), polybutylene terephthalate (PBT). The metallic body 11 is preferably made of magnesium alloy, and the plastic portion 12 is preferably made of PPS. Because the shrinkage of the PPS is relatively low and the linear expansion coefficient of the PPS substantially equals to that of the magnesium alloy, the plastic portion 12 can be firmly molded with the metallic body 11. The PPS has good heat-resistant character and corrosion-resistant character, and this is helpful for adopting surface treatment on the insert-molded member 10, for example, forming paint layer on an outer surface of the insert-molded member 10 by painting techniques.

The metallic body 11 and the plastic portion 12 are joined together without gaps. In the illustrated embodiment, the bonding structures include a first bonding structure 13, a second bonding structure 14, and a third bonding structure 15. The first bonding structure 13 is configured for preventing the plastic portion 12 from moving relative to the metallic body along an X-axis, a Y-axis, or a Z-axis. The second bonding structure 14 is configured for preventing the plastic portion 12 from moving relative to the metallic body along the X-axis, or the Y-axis. The third bonding structure 15 is also configured for preventing the plastic portion 12 from moving relative to the metallic body along the X-axis, the Y-axis, or the Z-axis.

Turning to a method for making the insert-molded member 10, the method includes the following two main steps. In a first step, a metallic body 11 including a plurality of bonding portions 110 formed at an edge is provided. The metallic body can be made by metal manufacturing methods such as compression molding, casting, pressing forming, forging, and punching. The metallic body 11 is preferably made by compression molding. The bonding portions 110 can be formed on the metallic body 11 by compression molding or formed by a computerized numerical control (CNC) machine. In a second step, a plastic portion 12 is integrally formed with the metallic body 11 by insert-molding technology. In an insert-molding process, the metallic body 11, as an insert member, is inserted into an injection mold, and then melted plastic is injected into the injection mold to form the plastic portion 12 on the metallic body 11. The melted plastic are joined around the bonding portions 110 to form a plurality of bonding structures for improving the bonding strength between the metallic body 11 and the plastic portion 12.

It should be pointed out that, after the first step, the metallic body 11 may be polished. An oxidation layer can be formed on the metallic body 11 for improving the bonding strength between the metallic body 11 and the plastic portion 12. The oxidation layer is preferably formed by one of micro-arc oxidation and anodic oxidation. In addition, after the second step, a paint layer can be applied on an outer surface of the insert-molded member 10 by painting techniques so that the insert-molded member 10 has a nice appearance.

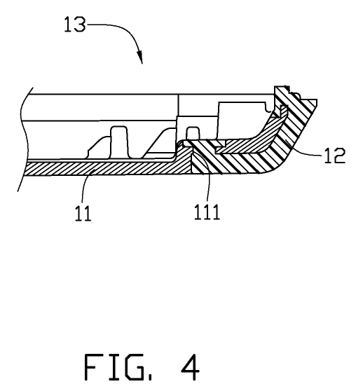

Referring to FIG. 4, the first bonding structure 13 can be formed by the flowing process. A stepped hole 111 is formed in a side portion of the metallic body 11 by a CNC machine. The stepped hole 111 has a larger diameter at an end adjacent to an inner surface of the insert-molded member 10 than an end adjacent to an outer surface of the insert-molded member 10. In the insert-molding process, the melted plastic flows into the stepped hole 111, thus the stepped hole 111 becomes filled with melted plastic. After the melted plastic is cooled, the stepped hole 111 and the plastic cooperatively form the first bonding structure 13.

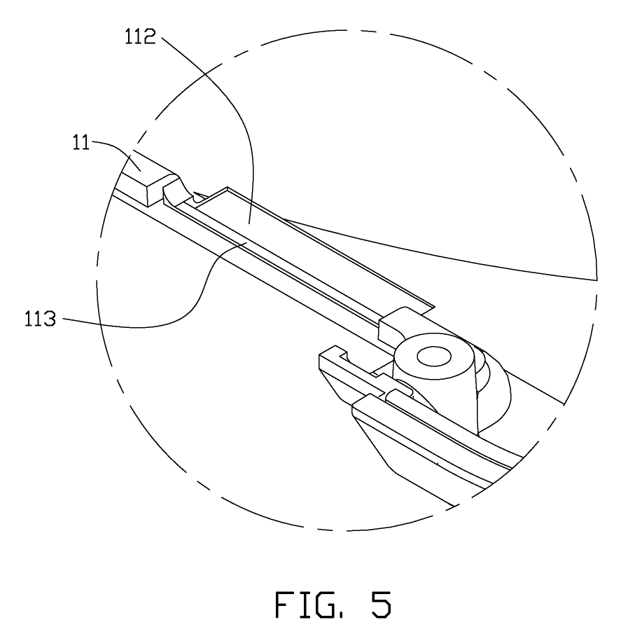

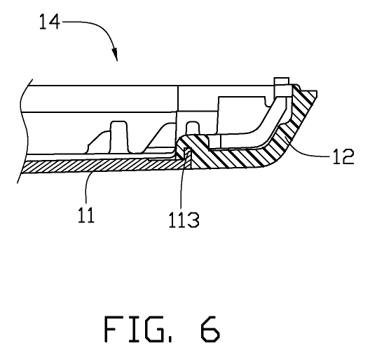

Referring to FIGS. 5 and 6, the second bonding structure 14 can be formed by the flowing process. A groove 112 is formed in a side portion of the metallic body 11 by a CNC machine and an extending piece 113 is formed adjacent to the groove 112. The shape of the extending piece 113 is rectangular, elliptical or another shape. In the insert-molding process, the melted plastic flows into the groove 112 and joins around the extending piece 113. After the melted plastic is cooled, the extending piece 113, and the plastic cooperatively form the second bonding structure 14.

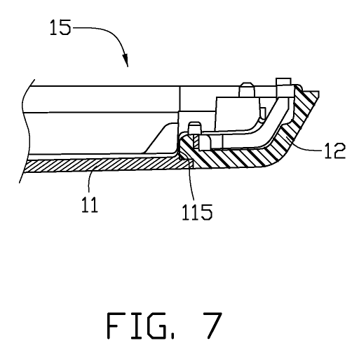

Referring to FIG. 7, the third bonding structure 15 can be formed by the flowing process. A through hole 115 is formed in the side portion of the metallic body 11 by a CNC machine. In the insert-molding process, the melted plastic flows into the through hole 115, thus the through hole 115 becomes filled with melted plastic. After the melted plastic is cooled, the through hole 115 and the plastic cooperatively form the third bonding structure 15.

It should be pointed out that, the stepped hole 111, the groove 112, and the extending piece 113 can also be directly formed by casting in the process of forming the metallic body. The insert-molded member 10 may include only one or two of the first bonding structure 13, the second bonding structure 14, or the third bonding structure 15. The bonding portions 110 include but not limited to the stepped hole 111, the groove 112, and the extending piece 113. The bonding portions 110 may also include others similar structures such as hooks, and T-shaped blocks.

Because the insert-molded member 10 includes a plurality of bonding structures, such as the first bonding structures 13, the second bonding structures 14, and the third bonding structures 15, the plastic portion 12 can be firmly molded with the metallic body 11. In addition, the plastic portion 12 is made of a material whose shrinkage is relatively low, and whose linear expansion coefficient substantially equals to that of the metallic material of the metallic body, thus the bonding strength between the metallic body 11 and the plastic portion 12 is further improved and the plastic portion 12 has relatively low inner stress. Therefore, distortion or crack rarely takes place on the insert-molded member 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An insert-molded member, comprising:
a metallic body made of metallic material selected from the group consisting of magnesium alloy, aluminum alloy and titanium alloy;
a plastic portion integrally formed with the metal body, and made of material selected from the group consisting of liquid crystal polymer, polyphenylene sulfide and polybutylene terephthalate; and
at least one bonding structure formed between the metallic body and the plastic portion.

2. The insert-molded member as claimed in claim 1, wherein the at least one bonding structure comprises at least one bonding portion formed at an edge of the metallic body configured for joining with the plastic portion.

3. The insert-molded member as claimed in claim 2, wherein the at least one bonding portion is a stepped hole.

4. The insert-molded member as claimed in claim 2, wherein the at least one bonding portion is a groove.

5. The insert-molded member as claimed in claim 2, wherein the at least one bonding portion is an extending piece.

6-9. (canceled)
